(19) United States
(12) Patent Application Publication
(10) Pub. No.: US 2015/0066651 A1
(43) Pub. Date: Mar. 5, 2015

(54) Method and System for Secure Mobile Payment Processing and Data Analytics

(71) Applicant: MasterCard International Incorporated, Purchase, NY (US)

(72) Inventors: Po HU, Norwalk, CT (US); Jean-Pierre Gerard, Croton-On-Hudson, NY (US); Rohit Chauhan, Somers, NY (US)

(73) Assignee: MasterCard International Incorporated, Purchase, NY (US)

(21) Appl. No.: 14/017,624

(22) Filed: Sep. 4, 2013

(51) Int. Cl. G06Q 20/40; G06Q 20/04; G06Q 30/02; G06Q 20/20

(52) U.S. Cl. CPC G06Q 20/40; G06Q 20/20; G06Q 20/0453; G06Q 30/0268
USPC 705/14.65; 705/16

(57) ABSTRACT

A method for processing payment transactions includes: storing a plurality of consumer profiles, wherein each consumer profile includes data related to a consumer including at least a combined identifier and at least two payment account identifiers; receiving an authorization request for a payment transaction originating from a point of sale device, wherein the authorization request includes at least a combined identification; identifying a specific consumer profile where the included combined identifier corresponds to the combined identification; transmitting at least the at least two payment account identifiers included in the specific consumer profile to the point of sale device; receiving an indication of one of the at least two payment account identifiers from the point of salve device; updating the authorization request to include at least the indicated one of the at least two payment account identifiers; and transmitting the updated authorization request.

### FIELD

The present disclosure relates to the processing of payment transactions, specifically the use of a safe transaction bureau to safely and securely process payment transactions via a mobile device.

### BACKGROUND

Mobile communication devices, such as cellular phones, smart phones, and tablet computers, are sometimes used to conduct a payment transaction with a merchant. In some instances, the mobile device is specifically configured to provide payment information for the payment method to be used to fund a particular payment transaction. A number of methods have been developed for storing and communication payment credentials via a mobile device, such as storing payment information in a Secure Element (a tamper proof chip capable to provide applications with the required level of security and features that could be integrated in various form factors: SIM Cards, embedded in the handset or SD Card) and transmitting it to a merchant point of sale device using near field communication.

However, these existing methods often rely on storing sensitive payment information on the mobile device, which is used during the transaction in lieu of a traditional payment card. As a result, the payment information can be similarly subject to theft. Protection of the information may require significant security measures to be taken by the mobile device and/or the consumer, which may be inefficient and time consuming, particularly during the transaction itself. In addition, many of these existing methods are configured to use only credit cards, which may inhibit a consumer from using other traditional payment methods, such as by check or debit card.

Thus, there is a need for a technical solution to provide for a safe payment transaction processing method via a mobile device that may be configured to use multiple types of payment accounts to fund the payment transaction.

### SUMMARY

The present disclosure provides a description of systems and methods for processing payment transactions.

A method for processing payment transactions includes: storing, in a consumer database, a plurality of consumer profiles, wherein each consumer profile includes data related to a consumer including at least a combined identifier and at least two payment account identifiers; receiving, by a receiving device, an authorization request for a payment transaction originating from a point of sale device, wherein the authorization request includes at least a combined identification; identifying, by a processing device, a specific consumer profile where the included combined identifier corresponds to the combined identification; transmitting, by a transmitting device, at least the at least two payment account identifiers included in the specific consumer profile to the point of sale device; receiving, by the receiving device, an indication of one of the at least two payment account identifiers from the point of salve device; updating, by the processing device, the authorization request to include at least the indicated one of the at least two payment account identifiers; and transmitting, by the transmitting device, the updated authorization request.

Another method for processing a payment transaction includes: reading, by a reading device, a machine-readable code displayed by a mobile communication device; decoding, by a processing device, the read machine-readable code to identify an encoded combined identifier; generating, by the processing device, an authorization request for a payment transaction including at least the combined identifier; transmitting, by a transmitting device, the generated authorization request; receiving, by a receiving device, at least two payment account identifiers; displaying, by a display device, the received at least two payment account identifiers; receiving, by an input device, an indication of one of the at least two payment account identifiers; and transmitting, by the transmitting device, the received indicated of one of the at least two payment account identifiers.

A system for processing payment transactions includes a consumer database, receiving device, processing device, and transmitting device. The consumer database is configured to store a plurality of consumer profiles, wherein each consumer profile includes data related to a consumer including at least a combined identifier and at least two payment account identifiers. The receiving device is configured to receive an authorization request for a payment transaction originating from a point of sale device, wherein the authorization request includes at least a combined identification. The processing device is configured to identify a specific consumer profile where the included combined identifier corresponds to the combined identification. The transmitting device is configured to transmit at least the at least two payment account identifiers included in the specific consumer profile to the point of sale device. The receiving device is further configured to receive an indication of one of the at least two payment account identifiers from the point of salve device. The processing device is further configured to update the authorization request to include at least the indicated one of the at least two payment account identifiers. The transmitting device is further configured to transmit the updated authorization request.

Another system for processing a payment transaction includes a reading device, processing device, transmitting device, receiving device, display device, and input device. The reading device is configured to read a machine-readable code displayed by a mobile communication device. The processing device is configured to: decode the read machine-readable code to identify an encoded combined identifier; and generate an authorization request for a payment transaction including at least the combined identifier. The transmitting device is configured to transmit the generated authorization request. The receiving device is configured to receive at least two payment account identifiers. The display device configured to display the received at least two payment account identifiers. The input device is configured to receive an indication of one of the at least two payment account identifiers. The transmitting device is further configured to transmit the received indicated of one of the at least two payment account identifiers.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for processing payment transactions in accordance with exemplary embodiments.

FIG. 2 is a block diagram illustrating the processing server of FIG. 1 for the processing of payment transactions in accordance with exemplary embodiments.

FIG. 3 is a block diagram illustrating the point of sale of FIG. 1 for the processing of payment transactions in accordance with exemplary embodiments.

FIGS. 4A-4C, in combination, is a flow diagram illustrating a method for the safe processing of a payment transaction in accordance with exemplary embodiments.

FIGS. 5A and 5B are diagrams illustrating a graphical user interface of a mobile device for providing payment information in accordance with exemplary embodiments.

FIGS. 6A and 6B are diagrams illustrating a graphical user interface of a point of sale device for conducting a payment transaction in accordance with exemplary embodiments.

FIGS. 7A and 7B are diagrams illustrating a graphical user interface for receiving and displaying offers following a payment transaction in accordance with exemplary embodiments.

FIGS. 8 and 9 are flow charts illustrating exemplary methods for processing payment transactions in accordance with exemplary embodiments.

FIG. 10 is a block diagram illustrating computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

Payment Account—A financial account that may be used to fund a transaction, such as a checking account, savings account, credit account, virtual payment account, etc. A payment account may be associated with an entity, which may include a person, family, company, corporation, governmental entity, etc. In some instances, a payment account may be virtual, such as those accounts operated by PayPal®, etc.

Payment Card—A card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or computer). For example, in some instances, data including a payment account number may be considered a payment card for the processing of a transaction funded by the associated payment account. In some instances, a check may be considered a payment card where applicable.

### System for Processing Payment Transactions

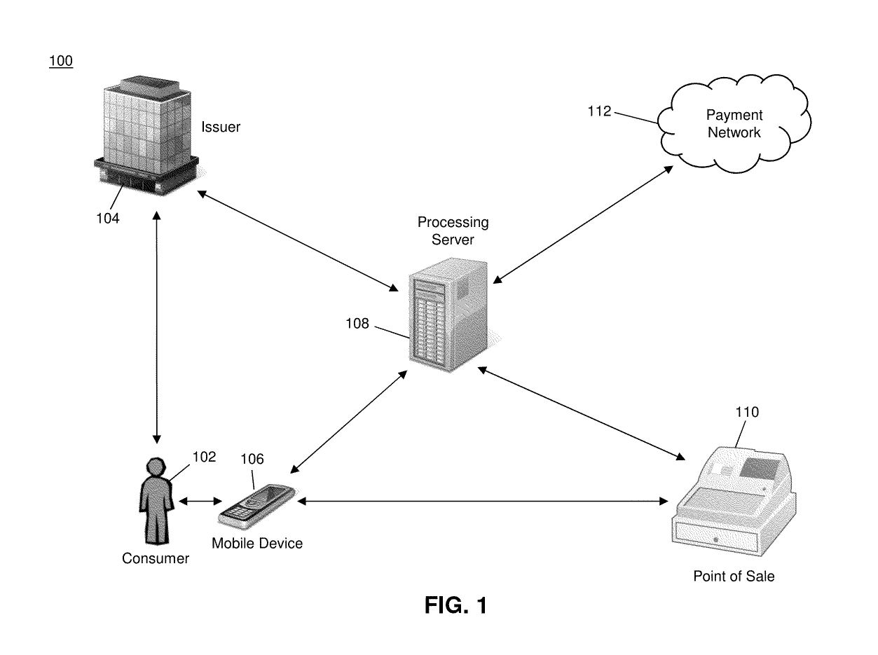

FIG. 1 illustrates a system 100 for processing payment transactions via a mobile device.

A consumer 102 may have one or more payment accounts with one or more issuers 104. The issuer 104 may be an issuing bank or other financial institution that may hold payment accounts with consumers, such as the consumer 102. The consumer 102 may be in possession of a mobile device 106, which may be a mobile communication device suitable for performing the functions as disclosed herein, such as a cellular phone, smart phone, tablet computer, notebook computer, etc.

The consumer 102 may have a desire to use the mobile device 106 to conduct payment transactions with a merchant. The consumer 102 may then register with a processing server 108 via the mobile device 106. Registering with the processing server 108 may include providing account information associated with one or more accounts that the consumer 102 wants to register for use in funding payment transactions. The account information, as well as device information associated with the mobile device 106, may be transmitted to the processing server 108 as part of the registration process.

The processing server 108, discussed in more detail below, may register the consumer 102 and associate the consumer 102 with the provided payment accounts. In some embodiments, the processing server 108 may communicate with the issuer 104, such as to verify the information provided by the consumer 102 and authenticate the consumer 102 as an authorized party with respect to the provided payment accounts. The processing server 108 may then identify a universal identifier to be associated with the consumer 102 and used for identification. The universal identifier may be any type of unique value suitable for use in performing the functions as disclosed herein as will be apparent to persons having skill in the relevant art, such as an identification number.

The processing server 108 may then transmit the universal identifier to the mobile device 106. In some embodiments, the interactions between the mobile device 106 and the processing server 108 may be performed via an application program executed by the mobile device 106. For example, the consumer 102 may register with the processing server 108 via the application program on the mobile device 106. Methods and systems for the use of an application program to communicate with a server and/or manage information will be apparent to persons having skill in the relevant art.

The mobile device 106 may store the universal identifier, and may also request additional authentication information from the consumer 102 prior to use in conducting payment transactions. The additional authentication information may be any information to be provided by the consumer 102 prior to a payment transaction, such as a password, personal identification number, biometric information (e.g., fingerprint), or any other value that may be suitable as will be apparent to persons having skill in the relevant art. In some embodiments, the processing server 108 may provide the additional authentication information to the consumer 102, such as a personal identification number.

The consumer 102 may then visit a merchant in order to engage in a payment transaction. The consumer 102 may initiate the payment transaction (e.g., by bringing goods for purchase to a cashier) and be asked to provide payment information. The consumer 102 may execute the application program on the mobile device 106 and may provide the additional authentication information to authenticate the consumer 102. The application program may then display a machine-readable code on a display of the mobile device 106 for reading by a point of sale device 110 at the merchant. The machine-readable code may be encoded with at least the universal identifier and the additional authentication information. In some embodiments, the machine-readable code may also be encoded with a device identifier, such as a media access control address.

The machine-readable code may be static, or, in some instances, dynamically generated by the mobile device 106. For example, the machine-readable code may be a dynamic barcode that may be different for each payment transaction. The machine-readable code may also be based on data received from the processing server 108 along with the universal identifier. Methods and systems for encoding and/or generating the machine-readable code will be apparent to persons having skill in the relevant art. In some embodiments, the machine-readable code may be a QR code. In other embodiments, an identifier (e.g., an identification number) may be used and displayed using the mobile device 106.

The point of sale 110 may read the machine-readable code or other identifier displayed by the mobile device 106, and may then decode the encoded information. The point of sale 110 may obtain a combined identifier from the machine-readable code, which may include the universal identifier and the additional authentication information. The point of sale 110 may then generate an authorization request for the payment transaction and include at least a transaction amount, a date and time of the transaction, an identifier associated with the point of sale 110, and the combined identifier.

The processing server 108 may receive the authorization request including the combined identifier. The processing server 108 may then authenticate the consumer 102 using the universal identifier and additional authentication information. Once the consumer 102 is authenticated, the processing server 108 may identify the payment accounts associated with the consumer 102 that were previously registered and transmit relevant information back to the point of sale 110. The point of sale 110 may then display a list of the registered payment accounts. The consumer 102 may select a payment account from the list to be used to fund the payment transaction.

The point of sale 110 may transmit an indication of the selected payment account to the processing server 108. The processing server 108 can then update the authorization request to include the account information for the selected payment account, and transmit the updated authorization request to a payment network 112 for processing using traditional systems and methods for processing payment transactions.

In some embodiments, once the payment transaction has been processed, the processing server 108 may transmit a notification to the mobile device 106, such as to notify the consumer 102 of the successful transaction. In some instances, the processing server 108 may identify offers for the purchase of goods and/or services based on the payment transaction or a transaction history of the consumer 102, as discussed in more detail below, and then transmit the offers to the consumer 102 for selection (e.g., via the mobile device 106 or the point of sale 110).

It will be apparent to persons having skill in the relevant art that the mobile device 106 may be any type of device suitable for performing the functions as disclosed herein, or that multiple devices may be used to perform the functions of the mobile device 106 discussed herein. For example, the consumer 102 may register with the processing server 108 using the mobile device 106, and then may receive an authentication device from the processing server 108. The authentication device may be used to accept the additional authentication information from the consumer 102 and generate the machine-readable code or identifier, which may be presented to the point of sale 110 to conduct the payment transaction. In such an embodiment, the mobile device 106 may not be needed in order to conduct the payment transaction.

In such a system and method as discussed herein, the use of the processing server 108 and the universal identifier may enable the consumer 102 to use the mobile device 106 to engage in a payment transaction without ever providing payment information to the merchant. As a result, payment account information of the consumer 102 may be more secure and at a much lower risk for theft or fraud. This may also be of a benefit to the merchant as well, as less instances of fraud could result in less loss by the merchant. In addition, the consumer 102 may be able to register multiple types of payment accounts with the processing server 108, such as a checking account, and could thereby easily select among a number of payment accounts of different types, without the need to carry multiple types of physical media.

### Processing Device

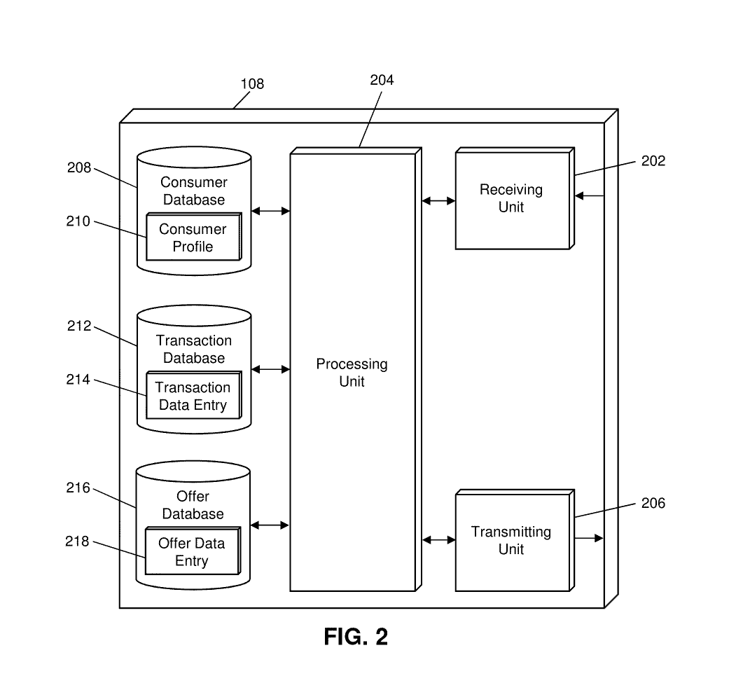

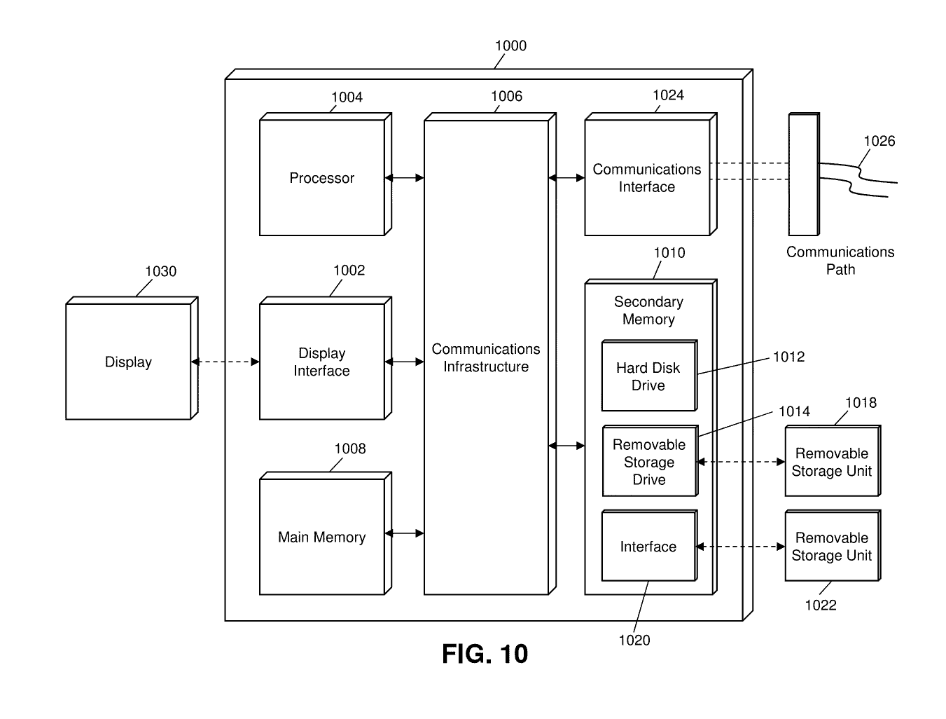

FIG. 2 illustrates an embodiment of the processing server 108 of the system 100. It will be apparent to persons having skill in the relevant art that the embodiment of the processing server 108 illustrated in FIG. 2 is provided as illustration only and may not be exhaustive to all possible configurations of the processing server 108 suitable for performing the functions as discussed herein. For example, the computer system 1000 illustrated in FIG. 10 and discussed in more detail below may be a suitable configuration of the processing server 108.

The processing server 108 may include a receiving unit 202. The receiving unit 202 may be configured to communicate with one or more networks via one or more network protocols to receive data. For example, the receiving unit 202 may be configured to receive registration information from the mobile device 106 to register the consumer 102. The processing server 108 may also include a processing unit 204, which may receive the information from the receiving unit 202 and validate the registration information provided by the consumer 102 using processes that will be apparent to persons having skill in the relevant art.

The processing server 108 may also include a transmitting unit 206. The transmitting unit may also be configured to communicate with one or more networks via one or more network protocols to transmit data. The transmitting unit 206 may transmit account information received as part of the registration information to the issuer 104 to authenticate the received account information. The receiving unit 202 may receive responses from the issuer 104, which may be analyzed by the processing unit 204 to determine if a particular payment account is authenticated and may be associated with the consumer 102.

Once the registration information and payment accounts have been validated, the processing unit 204 may create a consumer profile 210 corresponding to the consumer 102 and store the consumer profile in a consumer database 208. The consumer profile 210 may include at least payment account identifiers associated with the payment accounts registered by the consumer 102. The processing unit 204 may also identify and/or generate a universal identifier associated with the consumer 102, which may be transmitted to the mobile device 106 by the transmitting unit 206. In some embodiments, a token or other information used for generating and/or displaying the machine-readable code may also be transmitted to the mobile device 106.

The receiving unit 202 may also receive authentication information from the mobile device 106 based on the additional authentication information provided by the consumer 102. The processing unit 204 may then store the additional information in the consumer profile 210 associated with the consumer 102. In some embodiments, the processing unit 204 may combine the universal identifier and the additional information into a combined identifier, which may be stored in addition to or alternatively to the universal identifier in the consumer profile 210.

The receiving unit 202 may also be configured to receive an authorization request for a payment transaction including at least the combined identifier. The processing unit 204 may be configured to identify the consumer profile 210 for the consumer 102 based on the included combined identifier. The processing unit 204 may then identify at least two payment accounts registered in the consumer profile 210. The transmitting unit 206 may transmit information associated with the at least two payment accounts to the point of sale 110 for display to the consumer 102.

The receiving unit 202 may then receive a selected payment account from the point of sale 110. The processing unit 204 may then update the authorization request to include payment information associated with the selected payment account as included in the consumer profile 210. The transmitting unit 206 may then transmit the updated authorization request to the payment network 112 for processing.

In some embodiments, the processing server 108 may also include a transaction database 212. The transaction database 212 may be configured to store a plurality of transaction data entries 214. Each transaction data entry 214 may be associated with a consumer profile 210 (e.g., by the universal identifier, combined identifier, etc.) and may include data related to a payment transaction. The transaction data included in each transaction data entry 214 will be apparent to persons having skill in the relevant art, such as transaction time and/or date, transaction amount, merchant name, merchant category, geographic location, product data, etc. The transaction data may be received in authorization requests received by the receiving unit 202 and stored in the transaction database 212 as transaction data entries 214 by the processing unit 204.

The processing server 108 may also include an offer database 216. The offer database 216 may include a plurality of offer data entries 218, which may include data related to an offer for the purchase of goods or services including at least offer data and one or more selection criteria. The selection criteria may include criteria for selection the related offer for distribution to a consumer 102 based on the transaction data included in transaction data entries 214 associated with the consumer 102. For example, the selection criteria for an offer for an electronics store may be such that it is distributed to a consumer with a history of purchases at electronics stores of a specific value, or to consumers with a history of purchase close in proximity to the electronics store. Systems and methods for selecting an offer based on transaction history will be apparent to persons having skill in the relevant art.

The offer data may include at least one of: offer name, offer description, offer amount, offer category, offer type, merchant name, merchant category, start date, expiration date, quantity, and limitation on redemption. The processing unit 204 may be configured to identify a plurality of transaction data entries 214 associated with the consumer 102 and then identify one or more offer data entries 218 based on the transaction data included in the plurality of transaction data entries 214 and the selection criteria of the one or more offer data entries 218. The transmitting unit 206 may then transmit the offer data for the one or more offer data entries 218 to the consumer 102, such as via the point of sale 110 or the mobile device 106. The consumer 102 may then select an offer using methods and systems that will be apparent to persons having skill in the relevant art.

### Point of Sale Device

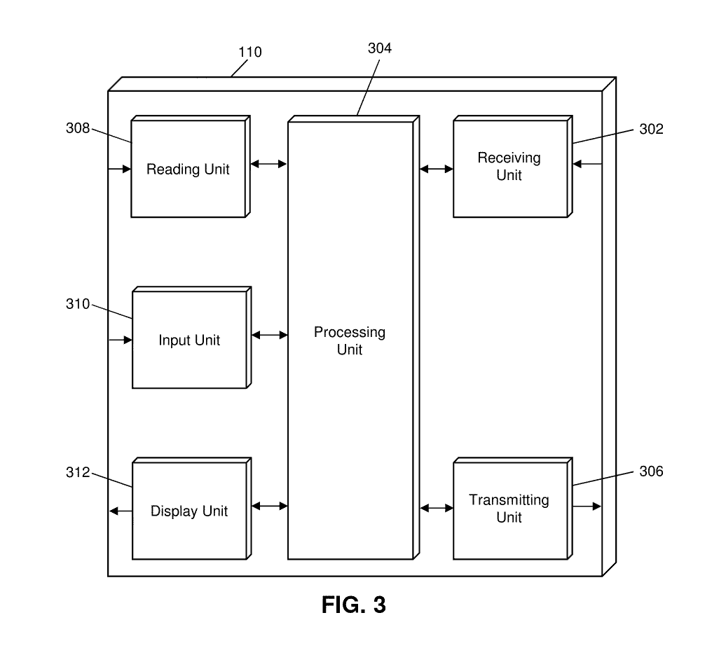

FIG. 3 illustrates an embodiment of the point of sale 110 of the system 100. It will be apparent to persons having skill in the relevant art that the embodiment of the point of sale 110 illustrated in FIG. 3 is provided as illustration only and may not be exhaustive to all possible configurations of the point of sale 110 suitable for performing the functions as discussed herein. For example, the computer system 1000 illustrated in FIG. 10 and discussed in more detail below may be a suitable configuration of the point of sale 110.

The point of sale 110 may include a reading unit 308. The reading unit 308 may be a camera or other type of reading device that may be configured to read a machine-readable code, such as a bar code or a QR code, displayed by the mobile device 106. The reading unit 308 may read the machine-readable code, and a processing unit 304 may decode the information encoded in the machine-readable code to obtain the combined identifier and/or the universal identifier and authentication information. The processing unit 304 may also generate an authorization request including transaction data and the information decoded from the machine-readable code.

The point of sale 110 may also include a transmitting unit 306. The transmitting unit 306 may be configured to transmit the generated authorization request to the processing server 108 using a suitable network and network protocol as will be apparent to persons having skill in the relevant art. The point of sale 110 may also include a receiving unit 302, which may receive at least two payment account identifiers from the processing server 108 for selection by the consumer 102.

A display unit 312 may display the at least two payment account identifiers for selection. The display unit 312 may be any type of display suitable for performing the functions disclosed herein, such as a liquid crystal display, light emitting diode display, capacitive touch display, etc. The consumer 102 may select from the at least two payment account identifiers, which may be received by an input unit 310. The input unit 310 may be a keyboard, mouse, touch screen, microphone, camera, or other suitable device configured to receive input from the consumer 102.

The transmitting unit 306 may then transmit an indication of the selected payment account to the processing server 108. The receiving unit 302 may then receive an authorization response indicating the approval or denial of the payment transaction. The indication of approval or denial may be displayed to the consumer 102 and/or an employee of the merchant via the display unit 312. The merchant may then finalize the payment transaction accordingly.

In one embodiment, the receiving unit 302 may also receive offer data for at least one offer from the processing server 108. In such an embodiment, the display unit 312 may display the offer data received from the processing server 108 to the consumer 102. In a further embodiment, the input unit 310 may be configured to receive a selection from the consumer 102 selecting one or more displayed offer for future use. The transmitting unit 306 may transmit an indication of the selected one or more offer to the processing server 108 for processing using systems and methods that will be apparent to persons having skill in the relevant art.

### Method for Processing Mobile Payment Transactions

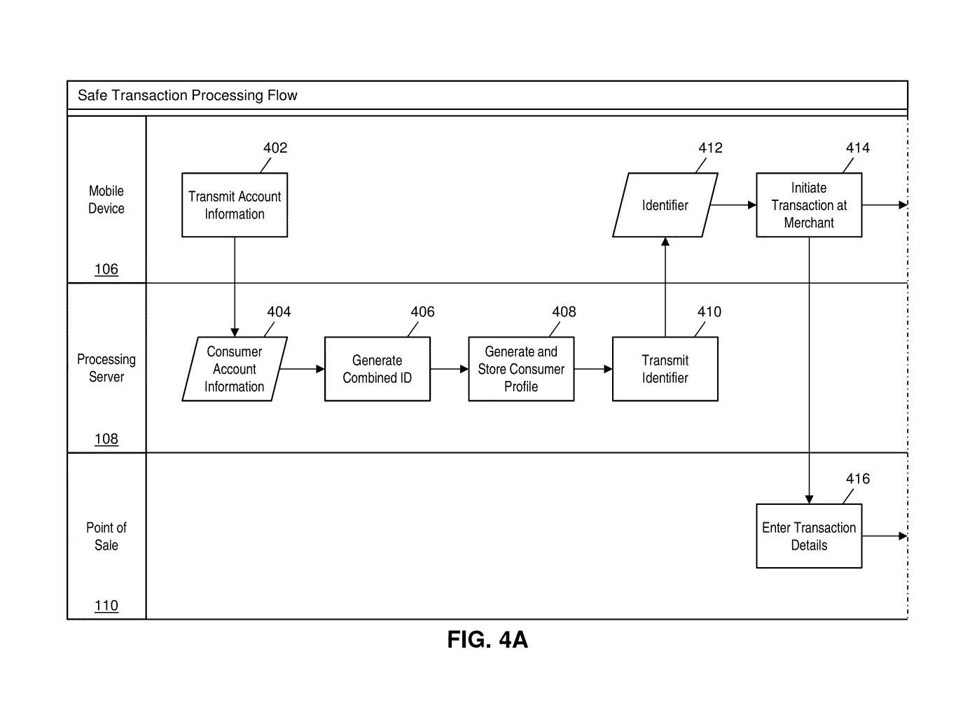

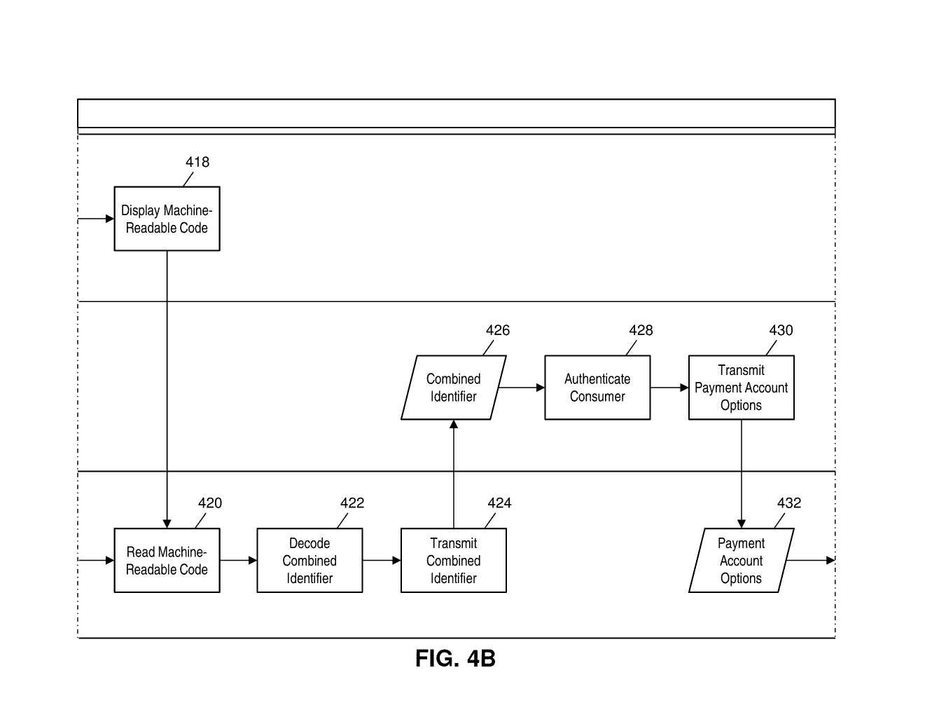

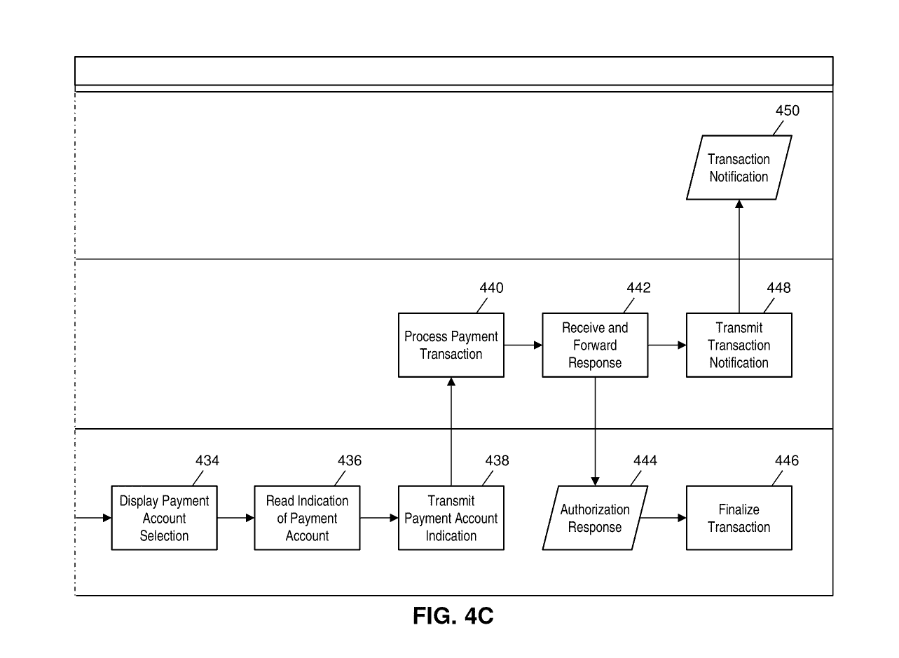

FIGS. 4A-4C illustrate a processing flow for processing payment transactions using the system 100 of FIG. 1.

In step 402, the mobile device 106 may transmit account information including payment information for at least two payment accounts to the processing server 108. The processing server 108 may receive the account information and any other additional registration information, such as a device identifier, in step 404. In step 406, the processing server 108 may generate a combined identifier to be associated with the consumer 102. The combined identifier may include a universal identifier and authentication information supplied by the consumer 102 via the mobile device 106 (e.g., and included in the account information).

In step 408, the processing server 108 may generate and store a consumer profile 210 associated with the consumer 102 in the consumer database 208. In step 410, the processing server 108 may transmit at least the combined identifier to the mobile device 106, which may receive the identifier in step 412. In step 414, the mobile device 106 (e.g., and/or the consumer 102 in possession of the mobile device 106) may initiate a payment transaction at a merchant.

In step 416, transaction details for the payment transaction may be entered into the point of sale 110 (e.g., by a user of the point of sale 110). In step 418, the consumer 102 may execute the application program on the mobile device 106, which may generate and display the machine-readable code encoded with the combined identifier. In step 420, the point of sale 110 may read the machine-readable code using the reading unit 308.

In step 422, the processing unit 304 of the point of sale 110 may decode the combined identifier from the machine-readable code, and then may, in step 424, transmit the combined identifier to the processing server 108. The processing server 108 may receive the combined identifier, in step 426, and then may authenticate the consumer 102 based on the combined identifier and data stored in the corresponding consumer profile 210, in step 428. The processing server 108 may identify eligible payment accounts for use in funding the transaction and may, in step 430, transmit at least two payment account options to the point of sale 110.

In step 432, the point of sale 110 may receive the payment account options. In some embodiments, the payment account options may be account identifiers, such as names or other information suitable for use by the consumer 102 to identify the corresponding payment account. In step 434, the point of sale 110 may display the at least two payment account options to the consumer 102. In step 436, the point of sale 110 may read an indication of a payment account to be used via the input unit 310.

In step 438, the point of sale 110 may transmit the indication of a payment account to the processing server 108. The processing server 108 may then process the payment transaction using the indicated payment account, in step 440. In some embodiments, processing the payment transaction may include updating the authorization request to include the indicated payment account, transmitting the updated authorization request to the payment network 112, and receiving an authorization response indicating approval or denial of the payment transactions.

In step 442, the processing server 108 may receive and forward an authorization response to the point of sale 110. The point of sale 110 may receive the authorization response in step 444, and then, in step 446, may finalize the transaction, such as by printing a receipt to give to the consumer 102. In step 448, the processing server 108 may transmit a notification of the transaction to the mobile device 106. The mobile device 106 may receive the notification, in step 450, which may then be displayed to the consumer 102. In some embodiments, the notification may include one or more offers for the purchase of goods or services. It will be apparent to persons having skill in the relevant art that steps 448 and 450 may be optional steps.

### Graphical User Interfaces

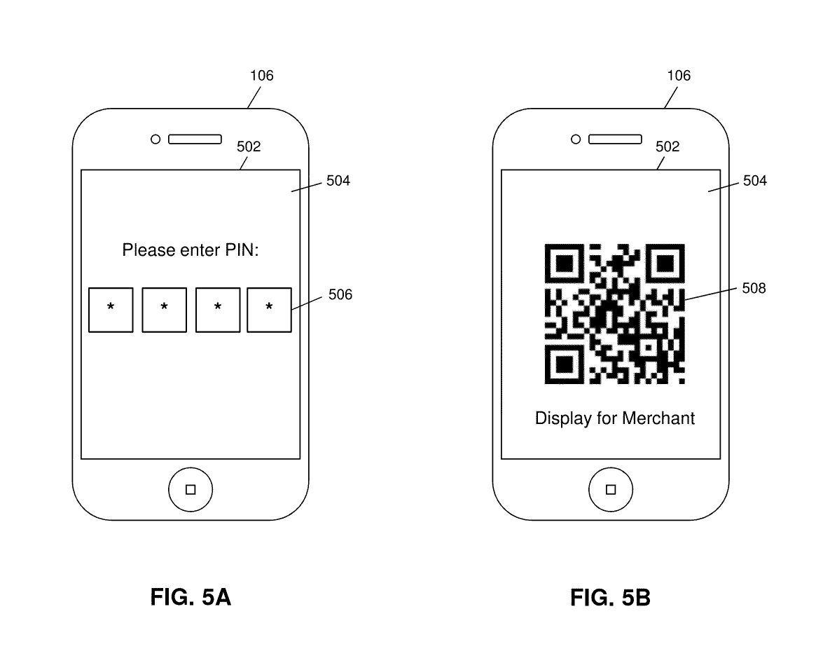

FIGS. 5A, 5B, 6A, 6B, 7A, and 7C illustrate exemplary graphical user interfaces for use in the system 100 of FIG. 1. It will be apparent to persons having skill in the relevant art that the interfaces illustrated and discussed herein are for use as illustration only, and that additional configurations and interfaces may be suitable for performing the functions as disclosed herein.

FIGS. 5A and 5B illustrate graphical user interfaces of the mobile device 106 for generating and displaying a machine-readable code encoded with the combined identifier for use in conducting the payment transaction. As illustrated in FIG. 5A, the mobile device 106 may include a display 502. The display 502 may be any suitable type of display, such as a capacitive touch display. The display 502 may display an authentication screen 504. The authentication screen 504 may be used to receive authentication information prior to a payment transaction.

The authentication screen 504 may include an authentication input 506. As illustrated in FIG. 5A, the authentication input 506 may be a number of input fields used to input a personal identification number. It will be apparent to persons having skill in the relevant art that additional or alternative authentication methods may be used, such as by inputting a password or fingerprint. Once the authentication information has been provided, the authentication screen 504 of the mobile device 106 may display a machine-readable code 508 encoded with the combined identifier, as illustrated in FIG. 5B.

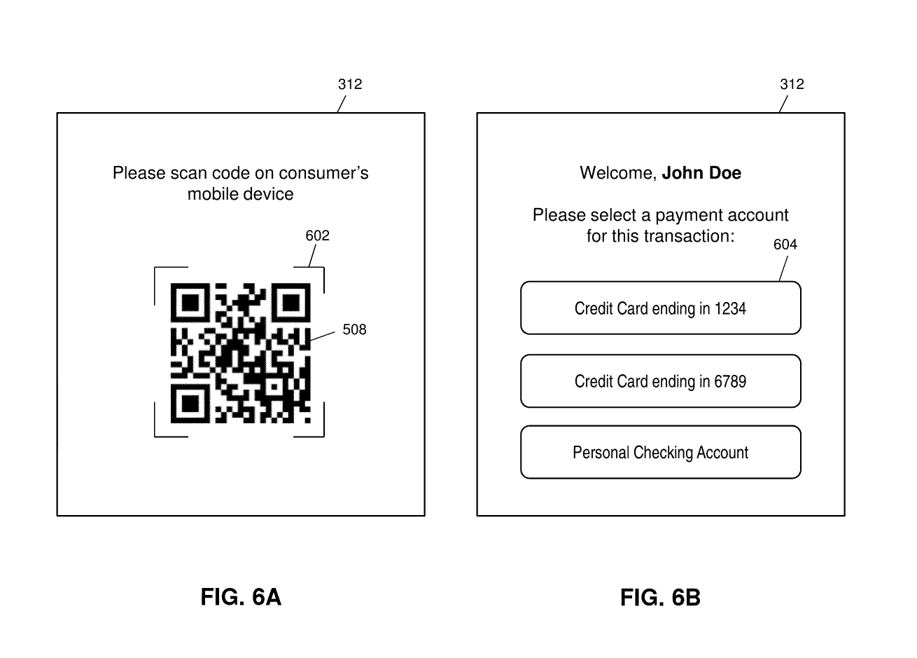

FIGS. 6A and 6B illustrate graphical user interfaces of the point of sale 110 for processing the payment transaction. As illustrated in FIG. 6A, the display unit 312 of the point of sale 110 may display a request for the machine-readable code 508. The display 312 may include a display area 602 representing an area being imaged by the reading unit 308. The display 502 of the mobile device 106 may be placed such that the machine-readable code 508 is inside of the display area 602. The reading unit 308 may then be able to read the machine-readable code 508 so that the processing unit 304 may decode the combined identifier.

Once the combined identifier has been read and transmitted to the processing server 108, the point of sale 110 may receive at least two payment accounts to be selected by the consumer 102. As illustrated in FIG. 6B, the point of sale 110 may display at least two account inputs 604, each of which may be associated with a payment account that may be used to fund the payment transaction. The consumer 102 may select one of the account inputs 604, which may result in the transmitting of an indication of the selected account to the processing server 108 for use in processing the payment transaction.

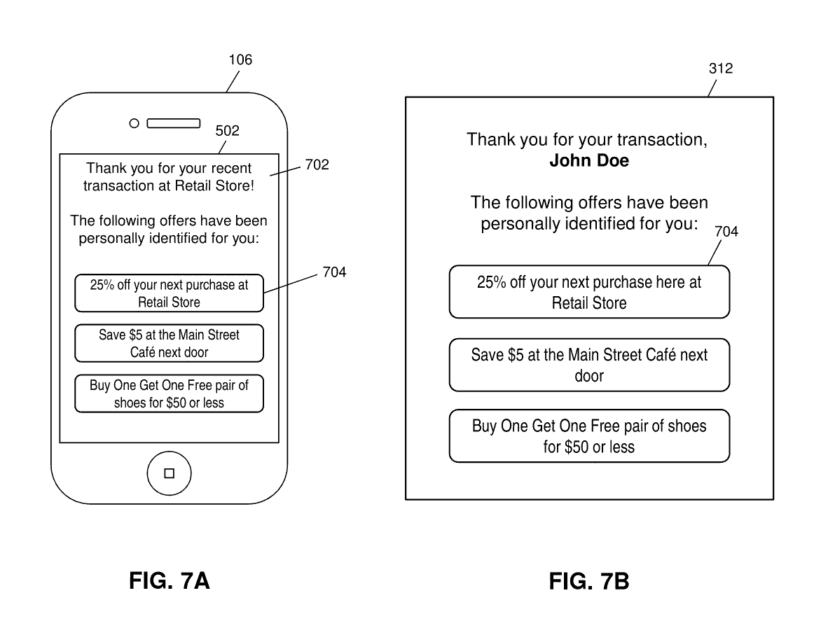

In some embodiments, the processing server 108 may transmit offer data related to one or more offers for display to the consumer 102 after processing the payment transaction. In such an embodiment, the offers may be displayed on the mobile device 106 and/or the point of sale 110. As illustrated in FIG. 7A, the display 502 of the mobile device 106 may include an offer display screen 702. The offer display screen 702 may display a notification of a completed transaction including one or more offers 704. In some instances, the consumer 102 may select an offer 704 in order to be eligible to redeem the corresponding offer.

FIG. 7B similarly illustrates the display of offers to the consumer 102, but as done via the point of sale 110. The display unit 312 of the point of sale 110 may display a notice of the completion of the payment transaction, along with one or more offers 704. In some instances, the consumer 102 may select an offer 704, and then the point of sale 110 may notify the processing server 108 of the selected offer. The processing server 108 may then register the offer with the consumer 102 using methods and systems that will be apparent to persons having skill in the relevant art.

### First Exemplary Method for Processing a Payment Transaction

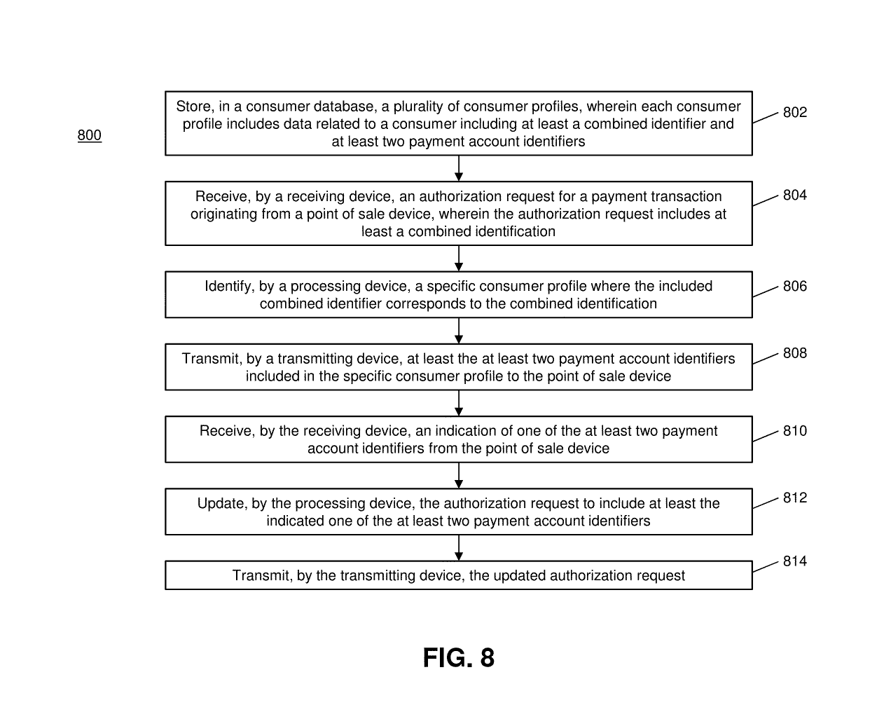

FIG. 8 illustrates an exemplary method 800 for processing a payment transaction via the mobile device 106.

In step 802, a plurality of consumer profiles (e.g., consumer profiles 210) may be stored in a consumer database (e.g., the consumer database 208), wherein each consumer profile 210 includes data related to a consumer (e.g., the consumer 102) including at least a combined identifier and at least two payment account identifiers. In one embodiment, each consumer profile 210 may further include a device identifier corresponding to a mobile communication device (e.g., the mobile device 106) associated with the related consumer 102 and a personal identification number, where the combined identifier is a combination of the device identifier and the personal identification number.

In step 804, a receiving device (e.g., the receiving unit 202) may receive an authorization request for a payment transaction originating from a point of sale device (e.g., the point of sale 110), wherein the authorization request includes at least a combined identification. In one embodiment, the combined identification may be encoded in a machine-readable code (e.g., the machine-readable code 508) read by the point of sale device 110. In some embodiments, the authorization request may further include at least a time and/or date, a transaction amount, and a terminal identifier associated with the point of sale device 110.

In step 806, a processing device (e.g., the processing unit 204) may identify a specific consumer profile 210 where the included combined identifier corresponds to the combined identification. In step 808, a transmitting device (e.g., the transmitting unit 206), may transmit at least the two payment account identifiers included in the specific consumer profile 210 to the point of sale device 110. In step 810, the receiving device 202 may receive an indication of one of the at least two payment account identifiers from the point of sale device 110. In step 812, the processing device 204 may update the authorization request to include at least the indicated one of the at least two payment account identifiers. In step 814, the transmitting device 206 may transmit the updated authorization request (e.g., to the payment network 112).

In one embodiment, the consumer profile 210 may further include a device identifier, and the method 800 may further include transmitting, by the transmitting device 206, a notification of the payment transaction to a mobile communication device (e.g., the mobile device 106) associated with the device identifier included in the specific consumer profile. In a further embodiment, the notification may include an electronic receipt for the payment transaction. In another further embodiment, the notification may be transmitted via at least one of: short message service message, multimedia message service message, e-mail, and an application program executed by the mobile communication device 106.

In some embodiment, the method 800 may further include storing, in a transaction database (e.g., the transaction database 212), a plurality of transaction data entries (e.g., transaction data entries 214), wherein each transaction data entry 214 includes data related to a payment transaction and includes at least a combined identifier included in a consumer profile 210 and transaction data. In one further embodiment, the authorization request may further include transaction data and the method 800 may further include storing, in the transaction database 212, a new transaction data entry 214 including at least the combined identifier included in the specific consumer profile and the transaction data included in the authorization request.

In another further embodiment, the method 800 may further include: storing, in an offer database (e.g., the offer database 216), a plurality of offer data entries (e.g., offer data entries 218), wherein each offer data entry includes data related to an offer for the purchase of goods or services including at least offer data end selection criteria; identifying, in the transaction database 212, a subset of transaction data entries, wherein each transaction data entry 214 in the subset of transaction data entries includes the combined identifier included in the specific consumer profile; identifying, in the offer database 216, at least one offer data entry 218 based on the transaction data included in each transaction data entry 214 of the subset of transaction data entries and the selection criteria included in the identified at least one offer data entry 218; and transmitting, by the transmitting device 206, the offer data included in the identified at least one offer data entry 218.

In an even further embodiment, the offer data included in the identified at least one offer data entry 218 transmitted to at least one of: the point of sale device 110 and a mobile communication device 106 associated with the consumer 102 related to the specific consumer profile 210. In another further embodiment, the offer data may include at least one of: an offer name, offer description, offer amount, offer category, offer type, merchant name, merchant category, start date, expiration date, quantity, and limitation on redemption.

### Second Exemplary Method for Processing a Payment Transaction

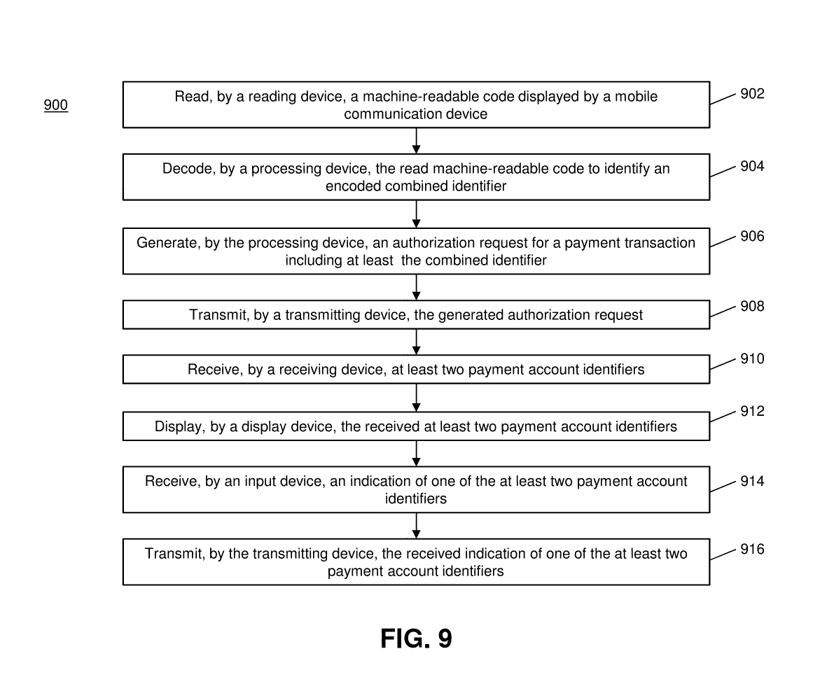

FIG. 9 illustrates an exemplary method 900 for processing a payment transaction via the mobile device 106.

In step 902, a reading device (e.g., the reading unit 308), may read a machine-readable code (e.g., the machine-readable code 508) displayed by a mobile communication device (e.g., the mobile device 106). In step 904, a processing device (e.g., the processing unit 304) may decode the read machine-readable code 508 to identify an encoded combined identifier. In one embodiment, the combined identifier may include at least a personal identification number associated with a consumer (e.g., the consumer 102) associated with the mobile communication device 106 and a device identifier associated with the mobile communication device 106.

In step 906, an authorization request for a payment transaction including at least the combined identifier may be generated, by the processing device 304. In one embodiment, the authorization request may further include a transaction time and/or date, a transaction amount, and a device identifier. In step 908, the generated authorization request may be transmitted by a transmitting device (e.g., the transmitting unit 306). In step 910, a receiving device (e.g., the receiving unit 302) may receive at least two payment account identifiers. In step 912, a display device (e.g., the display unit 312) may display the received at least two payment account identifiers.

In step 914, an indication of one of the at least two payment account identifiers may be received by an input device (e.g., the input unit 310). In step 916, the received indication of one of the at least two payment account identifiers may be transmitted by the transmitting device 306. In one embodiment, the method 900 may further include: receiving, by the receiving unit 302, offer data related to at least one offer for the purchase of goods or services, and displaying, by the display device 312, the received offer data.

### Computer System Architecture

FIG. 10 illustrates a computer system 1000 in which embodiments of the present disclosure, or portions thereof, may be implemented as computer-readable code. For example, the processing server 108 and the point of sale 110 of FIG. 1 may be implemented in the computer system 1000 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 4A-4C, 8 and 9.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 1018, a removable storage unit 1022, and a hard disk installed in hard disk drive 1012.

Various embodiments of the present disclosure are described in terms of this example computer system 1000. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 1004 may be a special purpose or a general purpose processor device. The processor device 1004 may be connected to a communication infrastructure 1006, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 1000 may also include a main memory 1008 (e.g., random access memory, read-only memory, etc.), and may also include a secondary memory 1010. The secondary memory 1010 may include the hard disk drive 1012 and a removable storage drive 1014, such as a floppy disk drive, a magnetic tape drive, an optical disk drive, a flash memory, etc.

The removable storage drive 1014 may read from and/or write to the removable storage unit 1018 in a well-known manner. The removable storage unit 1018 may include a removable storage media that may be read by and written to by the removable storage drive 1014. For example, if the removable storage drive 1014 is a floppy disk drive, the removable storage unit 1018 may be a floppy disk. In one embodiment, the removable storage unit 1018 may be non-transitory computer readable recording media.

In some embodiments, the secondary memory 1010 may include alternative means for allowing computer programs or other instructions to be loaded into the computer system 1000, for example, the removable storage unit 1022 and an interface 1020. Examples of such means may include a program cartridge and cartridge interface (e.g., as found in video game systems), a removable memory chip (e.g., EEPROM, PROM, etc.) and associated socket, and other removable storage units 1022 and interfaces 1020 as will be apparent to persons having skill in the relevant art.

Data stored in the computer system 1000 (e.g., in the main memory 1008 and/or the secondary memory 1010) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 1000 may also include a communications interface 1024. The communications interface 1024 may be configured to allow software and data to be transferred between the computer system 1000 and external devices. Exemplary communications interfaces 1024 may include a modem, a network interface (e.g., an Ethernet card), a communications port, a PCMCIA slot and card, etc. Software and data transferred via the communications interface 1024 may be in the form of signals, which may be electronic, electromagnetic, optical, or other signals as will be apparent to persons having skill in the relevant art. The signals may travel via a communications path 1026, which may be configured to carry the signals and may be implemented using wire, cable, fiber optics, a phone line, a cellular phone link, a radio frequency link, etc.

Computer program medium and computer usable medium may refer to memories, such as the main memory 1008 and secondary memory 1010, which may be memory semiconductors (e.g. DRAMs, etc.). These computer program products may be means for providing software to the computer system 1000. Computer programs (e.g., computer control logic) may be stored in the main memory 1008 and/or the secondary memory 1010. Computer programs may also be received via the communications interface 1024. Such computer programs, when executed, may enable computer system 1000 to implement the present methods as discussed herein. In particular, the computer programs, when executed, may enable processor device 1004 to implement the methods illustrated by FIGS. 4A-4C, 8 and 9, as discussed herein. Accordingly, such computer programs may represent controllers of the computer system 1000. Where the present disclosure is implemented using software, the software may be stored in a computer program product and loaded into the computer system 1000 using the removable storage drive 1014, interface 1020, and hard disk drive 1012, or communications interface 1024.

Techniques consistent with the present disclosure provide, among other features, systems and methods for processing payment transactions. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for processing payment transactions, comprising:
storing, in a consumer database, a plurality of consumer profiles, wherein each consumer profile includes data related to a consumer including at least a combined identifier and at least two payment account identifiers;
receiving, by a receiving device, an authorization request for a payment transaction originating from a point of sale device, wherein the authorization request includes at least a combined identification;
identifying, by a processing device, a specific consumer profile where the included combined identifier corresponds to the combined identification;
transmitting, by a transmitting device, at least the at least two payment account identifiers included in the specific consumer profile to the point of sale device;
receiving, by the receiving device, an indication of one of the at least two payment account identifiers from the point of salve device;
updating, by the processing device, the authorization request to include at least the indicated one of the at least two payment account identifiers; and
transmitting, by the transmitting device, the updated authorization request.

2. The method of claim 1, wherein each consumer profile further includes a device identifier, and the method further comprises:
transmitting, by the transmitting device, a notification of the payment transaction to a mobile communication device associated with the device identifier included in the specific consumer profile.

3. The method of claim 2, wherein the notification includes an electronic receipt for the payment transaction.

4. The method of claim 2, wherein the notification is transmitted via at least one of: short message service message, multimedia message service message, e-mail, and an application program executed by the mobile communication device.

5. The method of claim 1, wherein the combined identification is encoded in a machine-readable code read by the point of sale device.

6. The method of claim 1, wherein the authorization request further includes at least a time and/or date, a transaction amount, and a terminal identifier associated with the point of sale device.

7. The method of claim 1, wherein
each consumer profile further includes a device identifier corresponding to a mobile communication device associated with the related consumer and a personal identification number, and
the combined identifier is a combination of the device identifier and the personal identification number.

8. The method of claim 1, further comprising:
storing, in a transaction database, a plurality of transaction data entries, wherein each transaction data entry includes data related to a payment transaction and includes at least a combined identifier included in a consumer profile and transaction data.

9. The method of claim 8, wherein the authorization request further includes transaction data, and the method further comprises:
storing, in the transaction database, a new transaction data entry including at least the combined identifier included in the specific consumer profile and the transaction data included in the authorization request.

10. The method of claim 8, further comprising:
storing, in an offer database, a plurality of offer data entries, wherein each offer data entry includes data related to an offer for the purchase of goods or services including at least offer data and selection criteria;
identifying, in the transaction database, a subset of transaction data entries, wherein each transaction data entry in the subset of transaction data entries includes the combined identifier included in the specific consumer profile;
identifying, in the offer database, at least one offer data entry based on the transaction data included in each transaction data entry of the subset of transaction data entries and the selection criteria included in the identified at least one offer data entry; and
transmitting, by the transmitting device, the offer data included in the identified at least one offer data entry.

11. The method of claim 10, wherein the offer data included in the identified at least one offer data entry is transmitted to at least one of: the point of sale device and a mobile communication device associated with the consumer related to the specific consumer profile.

12. The method of claim 10, wherein the offer data includes at least one of: an offer name, offer description, offer amount, offer category, offer type, merchant name, merchant category, start date, expiration date, quantity, and limitation on redemption.

13. A method for processing a payment transaction, comprising:
reading, by a reading device, a machine-readable code displayed by a mobile communication device;
decoding, by a processing device, the read machine-readable code to identify an encoded combined identifier;
generating, by the processing device, an authorization request for a payment transaction including at least the combined identifier;
transmitting, by a transmitting device, the generated authorization request;
receiving, by a receiving device, at least two payment account identifiers;
displaying, by a display device, the received at least two payment account identifiers;
receiving, by an input device, an indication of one of the at least two payment account identifiers; and
transmitting, by the transmitting device, the received indicated of one of the at least two payment account identifiers.

14. The method of claim 13, wherein the authorization request further includes a transaction time and/or date, a transaction amount, and a device identifier.

15. The method of claim 13, wherein the combined identifier includes at least a personal identification number associated with a consumer associated with the mobile communication device and a device identifier associated with the mobile communication device.

16. The method of claim 13, further comprising:
receiving, by the receiving device, offer data related to at least one offer for the purchase of goods or services; and
displaying, by the display device, the received offer data.

17. A system for processing payment transactions, comprising:
a consumer database configured to store a plurality of consumer profiles, wherein each consumer profile includes data related to a consumer including at least a combined identifier and at least two payment account identifiers;
a receiving device configured to receive an authorization request for a payment transaction originating from a point of sale device, wherein the authorization request includes at least a combined identification;
a processing device configured to identify a specific consumer profile where the included combined identifier corresponds to the combined identification; and
a transmitting device configured to transmit at least the at least two payment account identifiers included in the specific consumer profile to the point of sale device, wherein
the receiving device is further configured to receive an indication of one of the at least two payment account identifiers from the point of salve device;
the processing device is further configured to update the authorization request to include at least the indicated one of the at least two payment account identifiers; and
the transmitting device is further configured to transmit the updated authorization request.

18. The system of claim 17, wherein
each consumer profile further includes a device identifier, and
the transmitting device is further configured to transmit a notification of the payment transaction to a mobile communication device associated with the device identifier included in the specific consumer profile.

19. The system of claim 18, wherein the notification includes an electronic receipt for the payment transaction.

20. The system of claim 18, wherein the notification is transmitted via at least one of: short message service message, multimedia message service message, e-mail, and an application program executed by the mobile communication device.

21. The system of claim 17, wherein the combined identification is encoded in a machine-readable code read by the point of sale device.

22. The system of claim 17, wherein the authorization request further includes at least a time and/or date, a transaction amount, and a terminal identifier associated with the point of sale device.

23. The system of claim 17, wherein
each consumer profile further includes a device identifier corresponding to a mobile communication device associated with the related consumer and a personal identification number, and
the combined identifier is a combination of the device identifier and the personal identification number.

24. The system of claim 17, further comprising:
a transaction database configured to store a plurality of transaction data entries, wherein each transaction data entry includes data related to a payment transaction and includes at least a combined identifier included in a consumer profile and transaction data.

25. The system of claim 24, wherein
the authorization request further includes transaction data, and
the processing device is further configured to store, in the transaction database, a new transaction data entry including at least the combined identifier included in the specific consumer profile and the transaction data included in the authorization request.

26. The system of claim 24, further comprising:
an offer database configured to store a plurality of offer data entries, wherein each offer data entry includes data related to an offer for the purchase of goods or services including at least offer data and selection criteria, wherein
the processing device is further configured to
identify, in the transaction database, a subset of transaction data entries, wherein each transaction data entry in the subset of transaction data entries includes the combined identifier included in the specific consumer profile, and
identify, in the offer database, at least one offer data entry based on the transaction data included in each transaction data entry of the subset of transaction data entries and the selection criteria included in the identified at least one offer data entry, and
the transmitting device is further configured to transmit the offer data included in the identified at least one offer data entry.

27. The system of claim 26, wherein the offer data included in the identified at least one offer data entry is transmitted to at least one of: the point of sale device and a mobile communication device associated with the consumer related to the specific consumer profile.

28. The system of claim 26, wherein the offer data includes at least one of: an offer name, offer description, offer amount, offer category, offer type, merchant name, merchant category, start date, expiration date, quantity, and limitation on redemption.

29. A system for processing a payment transaction, comprising:
a reading device configured to read a machine-readable code displayed by a mobile communication device;
a processing device configured to
decode the read machine-readable code to identify an encoded combined identifier, and
generate an authorization request for a payment transaction including at least the combined identifier;
a transmitting device configured to transmit the generated authorization request;
a receiving device configured to receive at least two payment account identifiers;
a display device configured to display the received at least two payment account identifiers; and
an input device configured to receive an indication of one of the at least two payment account identifiers, wherein
the transmitting device is further configured to transmit the received indicated of one of the at least two payment account identifiers.

30. The system of claim 29, wherein the authorization request further includes a transaction time and/or date, a transaction amount, and a device identifier.

31. The system of claim 29, wherein the combined identifier includes at least a personal identification number associated with a consumer associated with the mobile communication device and a device identifier associated with the mobile communication device.

32. The system of claim 29, wherein
the receiving device is further configured to receive offer data related to at least one offer for the purchase of goods or services, and
the display device is further configured to display the received offer data.
